(19) United States
(12) Patent Application Publication
(10) Pub. No.: US 2019/0253747 A1
(43) Pub. Date: Aug. 15, 2019

(54) SYSTEMS AND METHODS FOR INTEGRATING AND DELIVERING OBJECTS OF INTEREST IN VIDEO

(71) Applicant: Vid Scale, Inc., Wilmington, DE (US)

(72) Inventors: Kumar Ramaswamy, Princeton, NJ (US); Jeffrey Allen Cooper, Rocky Hill, NJ (US); John Richardson, Lincolnshire, IL (US); Louis Kerofsky, San Diego, CA (US)

(21) Appl. No.: 16/315,852

(22) PCT Filed: Jul. 21, 2017
(86) PCT No.: PCT/US2017/043248

§ 371 Date: Jan. 7, 2019

Related U.S. Application Data
(60) Provisional application No. 62/365,868, filed on Jul. 22, 2016.

(51) Int. Cl. H04N 21/431; H04N 21/44; H04N 21/858; G06K 9/00; H04N 21/235

(52) U.S. Cl. CPC H04N 21/431; H04N 21/44008; H04N 21/2353; G06K 9/00744; H04N 21/858

(57) ABSTRACT

Systems and methods are described for providing clear areas related to objects of interest in a video display. In accordance with an embodiment, a method includes capturing, with a camera, a video frame of a scene; determining a camera orientation and camera location of the camera capturing the video; determining a location of an object of interest; mapping the location of the object of interest to a location on the video frame; determining an object-of-interest area based on the location of the object of interest on the video frame; determining a clear area on the video frame; transmitting a location of the clear area to a client device; and displaying the video frame and metadata associated with the object of interest in the clear area.

### CROSS-REFERENCE TO RELATED APPLICATION

The present application is a non-provisional filing of, and claims benefit under 35 U.S.C. §119(c) from, U.S. Provisional Patent Application Ser. No. 62/365,868, filed Jul. 22, 2016, entitled “SYSTEMS AND METHODS FOR INTEGRATING AND DELIVERING OBJECTS OF INTEREST IN VIDEO,” which is incorporated herein by reference in its entirety.

### BACKGROUND

In video broadcasting, displaying additional information on a video screen often improves an audience's viewing experience. For example, during a video broadcast of an American football game, the location of a first-down line may be displayed as a yellow line super-imposed on the video broadcast at the location of the first-down line. Additionally, a football player's name and statistics may be displayed on the video broadcast when the video broadcast is displaying video of the football player.

### SUMMARY

Systems and method described herein enable viewers of a video stream to selectively view supplemental annotation data regarding objects of interest in the video stream. Metadata is provided to a video client device that identifies the annotation data along with the location of one or more clear areas in the video frame in which the annotation data may be displayed if selected by the user. A clear area may also be referred to herein as an annotation area. In accordance with an embodiment, visual information from a video stream is fused with object-in-space information obtained from other location information sources. The other location information sources may be in the form of a radio frequency tracking system, radio frequency identification (RFID) tags, GPS, WiFi Locating Systems and the like. Coordinates of object-of-interest areas that surround objects of interest are determined based on the fused visual and object-in-space information and may be determined on a per-frame basis. Open areas, areas clear of the object-of-interest areas, are identified so that annotation data can be displayed near the selected object of interest without obscuring other objects of interest.

In accordance with an embodiment, a method includes capturing, with a camera, a video frame of a scene; determining a camera orientation and camera location of the camera capturing the video; determining a location of an object of interest; mapping the location of the object of interest to a location on the video frame; determining an object-of-interest area based on the location of the object of interest on the video frame; determining a clear area on the video frame; transmitting a location of the clear area to a client device; displaying the video frame; and displaying annotation data associated with the object of interest in the clear area.

Some exemplary embodiments provide a video serving method. In one such method, a plurality of object-of-interest areas are identified in at least one frame of a video stream. An annotation area is automatically selected for each of the object-of-interest areas, where the selection is performed such that each annotation area does not overlap any object-of-interest area in the frame. In some embodiments, annotation areas are selected so as not to overlap one another or the edge of the frame. The annotation areas may be selected so as to be proximate to their respective object-of-interest areas. The serving method further includes delivering to a recipient: (i) the video stream, (ii) annotation data regarding each of the respective object-of-interest areas, and (iii) location data that identifies the location of each annotation area within the frame. The annotation data may be text data. The location data may include pixel coordinates, such as coordinates that identify corners of a boundary box or that identify a center coordinate and size of the annotation area, among other alternatives. In some embodiments, the annotation data and location data are provided in-band in user data of the video stream. In some embodiments, the annotation data and location data are provided separately from the video data, such as in a manifest file of the video stream.

In some embodiments, the identification of at least a first one of the object-of-interest areas is performed by tracking a real-world position of a first object of interest using, e.g. a radio-frequency identification (RFID) tag on the first object of interest. At least the orientation (and in some embodiments the position) is determined of a camera that is capturing the frame of video. The real-world position of the first object of interest is fused with the orientation of the camera (and other information as needed, such as the camera position, zoom factor, and the like) to determine a frame position of the first object of interest within the frame. The frame position of the first object of interest may be given as pixel coordinates. The first object-of-interest area is then selected so as to at least partially surround the frame position of the first object of interest.

On the client side, a client device in some embodiments receives the video stream, the annotation data, and the location data and causes the video stream to be presented at a display. The client device accepts user input, and in response to a user input identifying a selected one of the objects of interest, the client device causes display of the annotation data associated with the selected object of interest in the annotation area associated with the selected object of interest.

In some embodiments, the coordinates of each of the object-of-interest areas are delivered to the client along with the video stream, the annotation data, and the location data. The client may use the coordinates of the object-of-interest areas as user input areas. For example, if a user provides input (such as a click or touch) at a selected position on a screen within the object-of-interest area, the client may responsively display (or stop displaying) the annotation information for the object-of-interest area that surrounds that selected position.

### BRIEF DESCRIPTION OF THE DRAWINGS

FIG. 1 is a schematic block diagram of an adaptive bit rate (ABR) video distribution system with zoom coding capabilities.

FIG. 2 illustrates an information flow diagram, in accordance with an embodiment.

FIG. 3 depicts a view of a playing field and a real-time location system, in accordance with an embodiment.

FIG. 4 illustrates a plurality of potential bounding boxes that may be selected from a frame of high-resolution video for zoomed display of an object of interest, in accordance with some embodiments.

FIG. 5 illustrates a plurality of potential bounding boxes that may be selected from a frame of high-resolution video for zoomed display of an object of interest, in accordance with some embodiments, in cases where the object of interest is near the edge of the frame of high-resolution video.

FIG. 6 illustrates a plurality of potential bounding boxes that may be selected from a frame of high-resolution video for zoomed display of an object of interest, along with a clear area and an object-of-interest area, in accordance with some embodiments.

FIG. 7A depicts a view of a video frame, in accordance with an embodiment.

FIG. 7B depicts a view of the video frame with object-of-interest areas, in accordance with an embodiment.

FIG. 7C depicts a view of the video frame with object of interest and clear areas, in accordance with an embodiment.

FIG. 7D depicts a display device on which a video is being displayed, in accordance with an embodiment.

FIG. 8 is a first message flow diagram, in accordance with an embodiment.

FIG. 9 is a second message flow diagram, in accordance with an embodiment.

FIG. 10A is a flow chart of a first method, in accordance with an embodiment.

FIG. 10B is a flow chart of a second method, in accordance with an embodiment.

FIG. 11 is a functional block diagram of a client device that may be used in some embodiments.

FIG. 12 is a functional block diagram of a network entity that may be used in some embodiments.

### DETAILED DESCRIPTION

### Distribution of Streaming Video Content

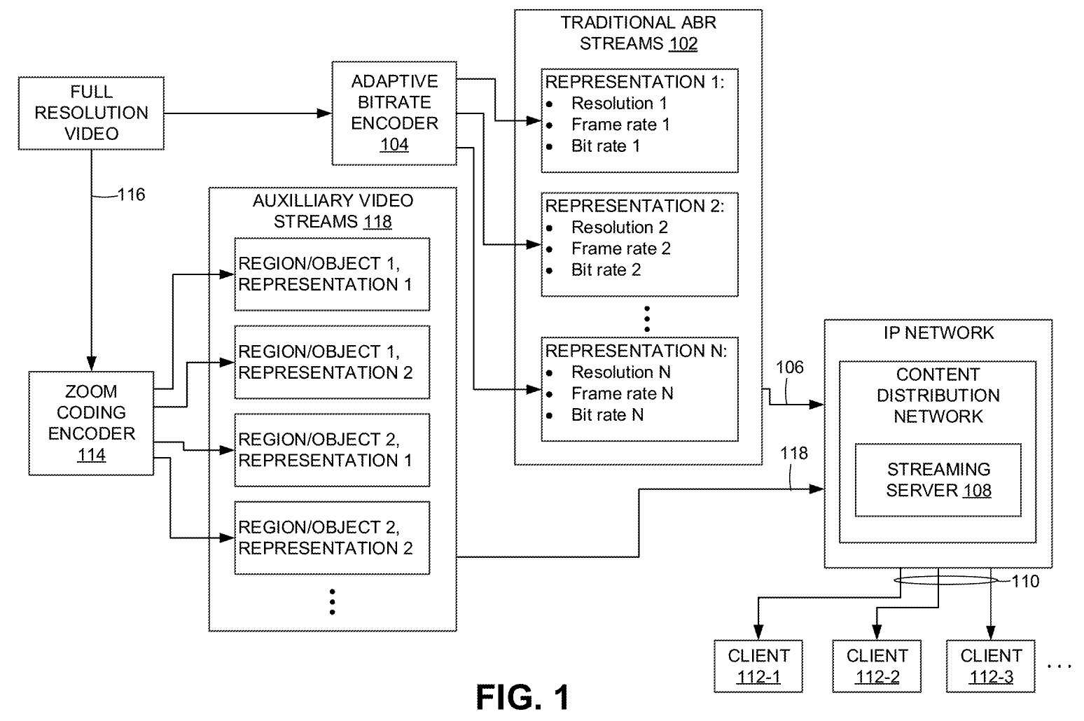

An exemplary functional architecture of an adaptive bitrate video distribution system with zoom coding features is illustrated in FIG. 1. Traditionally, an input full-resolution stream (4K resolution, for example) at a high bit depth may be processed and delivered at a lower resolution, such as high definition (HD), and lower bit depth, to an end consumer. In FIG. 1, traditional processing is represented in the components labeled “Traditional ABR Streams” 102. Using traditional adaptive bit rate (ABR) coding, an adaptive bit rate encoder 104 may produce ABR streams 106 that are published to a streaming server 108, and the streaming server 108 in turn delivers customized streams 110 to clients 112 (e.g., users or end customers).

An exemplary zoom coding encoder 114, shown in the bottom part of the workflow in FIG. 1, receives the high-bit-depth input video stream 116 and with a variety of techniques produces auxiliary video streams 118. These auxiliary video streams 118 may include, for example, streams representing cropped and/or zoomed portions of the original video streams to which different tone maps have been applied to different regions, or, as discussed in greater detail below, streams for different regions of interest. These auxiliary video streams 118 may in turn be encoded using traditional ABR techniques. A user of client 112 is presented with the choice of watching the normal, or original program (i.e., ABR stream(s) 106), (delivered using ABR profiles) and in addition, auxiliary (e.g., zoom coded) video streams 118 that may represent zoomed portions of the original program or other auxiliary streams relating to the original program. Once the user makes a choice to view a zoom coded stream, the client 112 may request an appropriate stream from the streaming server 108. The streaming server 108 may then deliver the appropriate stream to the client 112.

The streaming server 108 is configured to transmit a video stream over a network to different display devices associated with clients 112. The network may be a local network, the Internet, or other similar network. The display devices include devices capable of displaying the video, such as a television, computer monitor, laptop, tablet, smartphone, projector, and the like. The video stream may pass through an intermediary device, such as a cable box, a smart video disc player, a dongle, or the like. Each client 112 may remap the received video stream to best match the respective display and viewing conditions.

### Overview of Exemplary Embodiment

Systems and methods described herein enable viewers of a video stream to selectively view annotation data regarding objects of interest in the video stream. Metadata is provided to a video client device that identifies the annotation data along with the location of one or more clear areas in the video frame in which the annotation data may be displayed if selected by the user.

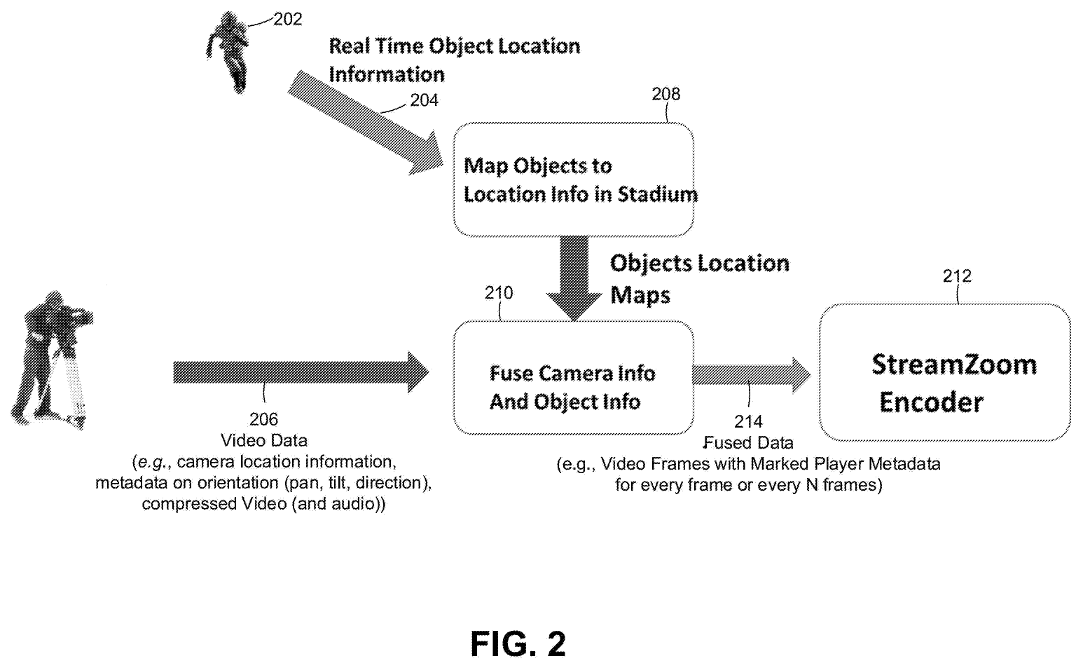

FIG. 2 is an information flow diagram, in accordance with an embodiment. In this embodiment, an object of interest is a professional athlete 202 being filmed for a television broadcast during a sporting event. Real-time object location information 204 is determined for each object of interest, for example, each athlete and a game ball have real time location information. The real time object location information may be determined in any number of ways. Examples include affixing or otherwise placing a marker, such as an RFID tag, on each object of interest, outfitting each object of interest with a position determination system such as a GPS receiver, using local wireless rangers, and the like. Each player 202 may be equipped with a unique marker that may be placed on any number of locations on the player, such as in a helmet, on a shoe, in a protective pad, or the like. The location information may also be determined or supplemented by video data 206. For example, optical recognition techniques may be used to identify labels or numbers on a player's uniform, the shape of the playing ball, object colors, object shapes, object movement characteristics, and the like. At 208, locations of the object(s) of interest are determined and mapped to location information for the venue, such as a stadium.

Video data 206 may include camera information, which may include information and/or metadata on the location and orientation of the camera, such as the pan, tilt, and direction the camera is pointed, and video and audio steams. The camera information may also be supplemented with the camera's visual settings, such as its optical zoom level, focus settings, and the like. Based on the camera's orientation, the camera's field-of-view volume may be determined. This volume may then be mapped into a camera frame, and the player's location within the volume may be fused into the camera frame at 210.

A stream zoom video encoder 212 then receives fused camera information and object information 214, with video frames marked with object-of-interest metadata for every frame or every set number of frames. The object of interest metadata may indicate the position of an object of interest within the frame, as well as possibly providing identification for each object of interest. With information available on a frame-by-frame basis, a trajectory may be built for any object of interest. The field-of-view volume may also be based on the camera's focal settings. In such an embodiment, an object of interest may be in the line of sight of the camera, but based on the focal settings may be out of focus, and thus not included in a determination (described below) of different object-of-interest areas and clear areas for that video frame.

Based on the information flow of FIG. 2, location information from each object of interest is obtained and mapped into each video image captured. The identified objects of interest can then be tracked through the video as they appear and disappear from the view of the camera.

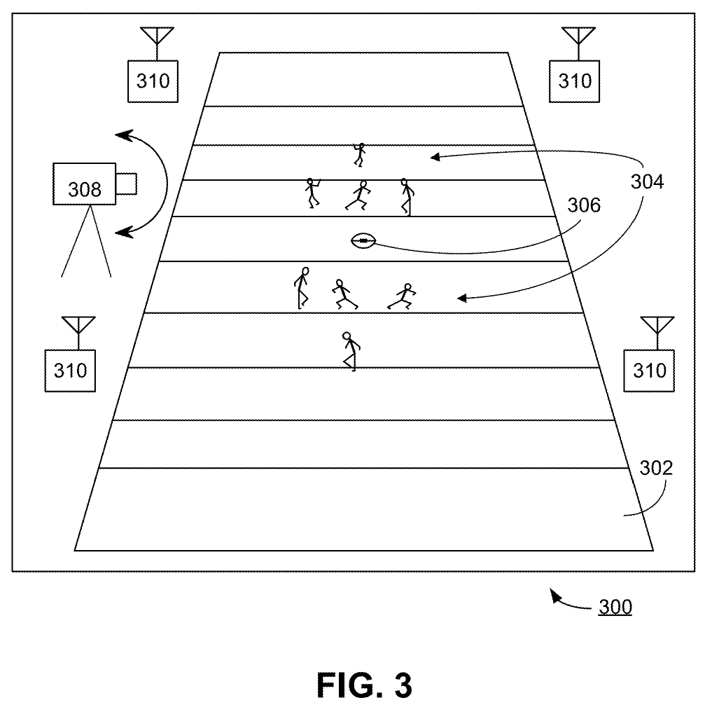

FIG. 3 depicts a view 300 of a playing field and a real-time location system, in accordance with an embodiment. In particular, view 300 includes a playing field 302, eight players 304, a ball 306, a video camera 308, and a real-time location system (RTLS) 310. The field 302 is shown as an American football field. The view 300 includes eight players 304, four on each side of the ball 306. Each of the eight players 304 and the ball 306 is equipped with an RFID tag that is configured to transmit a radio signal. The RTLS 310 receives the radio signals from the RFID tags and is able to determine a real time location for each object of interest based on the time-of-arrival (TOA) of each radio signal at the RTLS 310 receivers. The camera 308 records video and sound of the players 304 and the ball 306 on the field 302. The camera 308 is also able to determine its position relative to a reference position and its orientation relative to a reference orientation. The camera 308 may be equipped with a camera mount that is able to detect the pitch, roll, and translation of the camera 308 with respect to reference coordinates. In other embodiments, the camera 308 is equipped with an RFID tag, and the RTLS 310 determines the position and orientation of the camera 308 in relation to reference positions and orientations. The camera 308 then transmits the video, audio, and camera location and orientation information to a fuse mapping service configured to fuse the camera based information with the real time location information of the different objects of interest.

In mapping the video locations, an orthographic projection may be developed using the methods disclosed in, for example, Sheikh, Y., et. al. Geodetic Alignment of Aerial Video Frames Video Registration, The International Series in Video Computing, Vol 5., pp 144-179 Springer, Boston, Mass. (2003). Similarly, in mapping the real time location information, an orthographic projection may be made based on the identification of the tags (sensors), and their determined locations. Both the video-based and location-based orthographic projections may be fused onto any set of coordinates, such as GPS, Cartesian, polar, cylindrical, or any other set of coordinates suited to the environment. This embodiment may be extended to other embodiments with multiple video cameras. In such embodiments, different views of player positions appearing in the field of view of specific cameras can be collected and made available in a consolidated manner. A video stream may be compiled from all available views from different cameras that are available.

While the view 300 depicts a football field with players equipped with RFID tags, the scenario may be modified. For example, the field 302 may be replaced with an automobile race track, the players 304 may be replaced with automobiles equipped with GPS location technology and be able to transmit a determined GPS location to a server for mapping the locations of the automobiles on the race track for fusion with a video of the race. Other scenarios may be likewise accommodated (e.g. a soccer game, a baseball game, a golf tournament, the filming of a movie set or a news program, etc.) in which one or more cameras and one or more people and/or objects of interest may be similarly outfitted in order to provide the camera information and the object information as described herein.

A bounding box that surrounds an object of interest may be defined for each video frame in which the object of interest appears. The bounding box may be based on pixel coordinates of the video frame. For each object of interest, a clear area may be defined, where the clear area is selected to be an area that is proximate to the object of interest but that does not overlap the object-of-interest area of any object of interest. The clear area for an object of interest may be selected to be within a bounding box associated with that object of interest. The bounding box may, for example, represent a displayable region of the content which contains the object of interest. The clear area may be selected to be a large enough area to display annotation data associated to the object of interest, and this size may vary per object of interest depending on the volume of associated annotation data. With the coordinate position of each object of interest in the video frame identified, metadata is created to notify the client about the availability of different objects of interest, as well as bounding box or object of interest area information for such objects of interest, and to identify clear areas that are available for displaying annotation data for each selected object.

### Determination of a Bounding Box

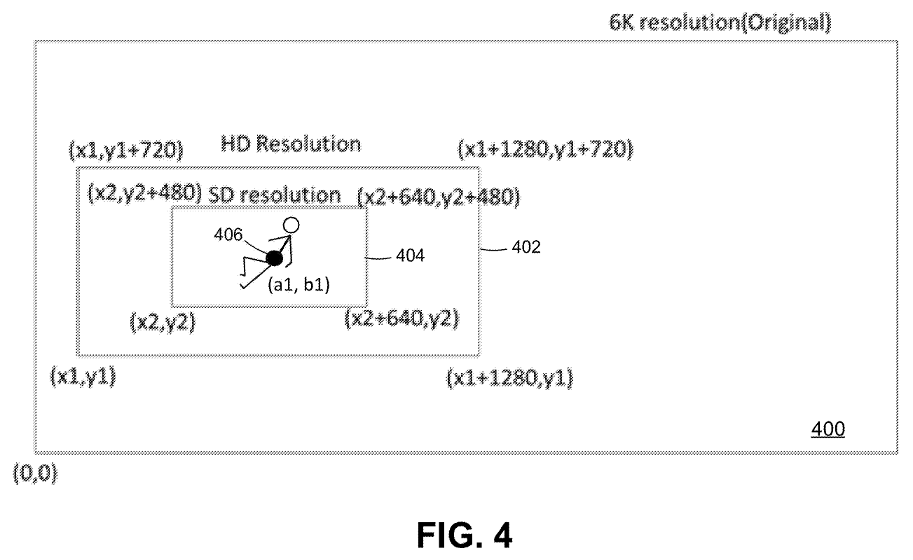

FIG. 4 illustrates a plurality of potential bounding boxes that may be selected from a video frame 400 of native-resolution video for zoomed display of an object of interest. The video frame 400 is at a native source resolution of, for example, 6K. Various bounding boxes may be defined to select portions of the video frame that can be presented at a lower resolution. For example, a bounding box 402 may be used to select a region with dimensions of 1280×720 pixels, which allows for presentation of video in high definition (HD). Another bounding box 404 may be used to select a region with dimensions of 640×480 pixels, which allows for presentation of video in standard definition (SD). The location of each corner of the different resolutions is depicted in Cartesian x and y coordinates. For the HD bounding box 402, the bottom left corner is located at (x₁, y₁), the top left corner at (x₁, y₁+720), the top right corner located at (x₁+1280, y₁+720), and the bottom right corner located at (x₁+1280, y₁). Similarly, for the SD bounding box 404, the bottom left corner is located at (x₂, y₂), the top left corner at (x₂, y₂+480), the top right corner located at (x₂+640, y₂+480), and the bottom right corner located at (x₂+640, y₂). The position of each bounding box may be determined automatically based on real-time information regarding the position and orientation of the camera and the location of the object of interest. As shown in FIG. 4, the real-time location of the object of interest is determined to be at the black dot 406 located at (a₁, b₁). The location of the object of interest is determined by any real time location service, and is fused into the location of the video view. In this embodiment, the player is known to be wearing an RFID tag near the waist. The bounding box is positioned such that the object of interest is at the center of the bounding box.

To select the position of HD bounding box 402 for the object of interest, x1 may be placed at a1−640 and y1 at b1−360. Similarly, to select the position of SD bounding box 404 for the object of interest, x2 may be placed at a1−320 and y2 at b1−240. Although only a single object of interest is shown in each of FIGS. 4, 5, and 6, in the more general case multiple objects of interest may be present, and some or all of the bounding boxes may contain or may overlap with other objects of interest in addition to the object of interest for which the bounding box was defined.

In some situations, it may be desirable to select a bounding box location that is not centered on the corresponding object of interest. For example, if a player wears an RFID tag on a helmet on his head, the bounding box may be positioned such that the location of the object of interest, point (a₁, b₁), is toward the top of the bounding box, leaving room for the player's body and legs to be in the middle portion and lower portion, respectively, of the region of interest frame when the player is vertical. In some embodiments, the orientation (standing, jumping, diving, etc.) may be determined for the player in selecting the position of the bounding box around the object of interest. Example methods for determining a player's orientation may include placing RFID sensors on the player's head and feet to determine two end-point locations of the player or correlating optical features of the video with the determined location.

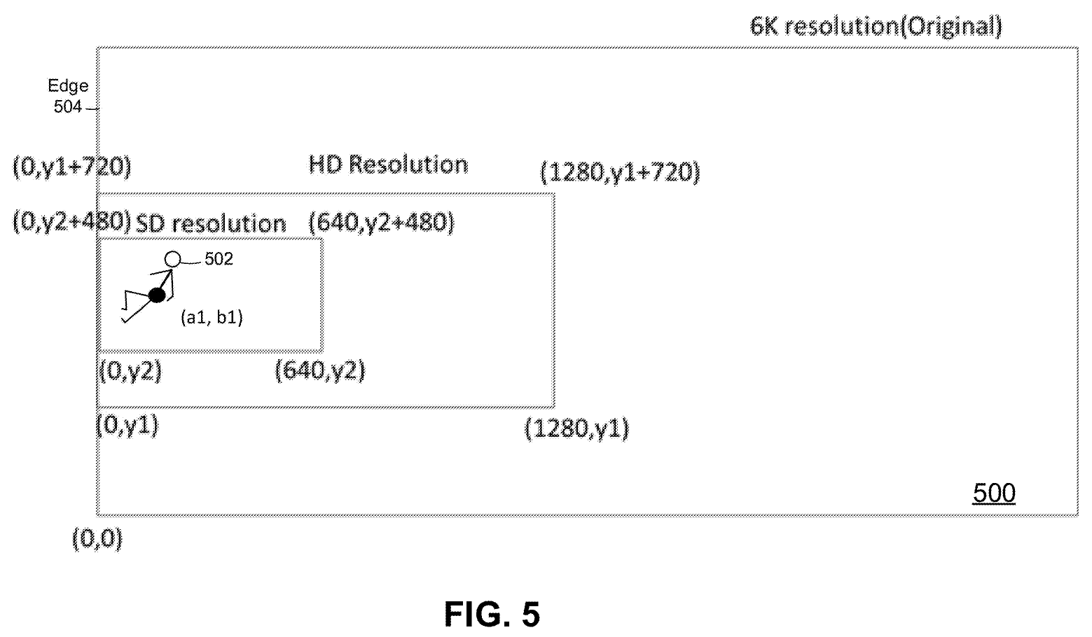

Another situation in which it may be desirable to select a bounding box location that is not centered on the corresponding object of interest is illustrated in FIG. 5. In the situation depicted in FIG. 5, an object of interest 502 is near an edge 504 of a native-resolution video frame 500. The view depicted in FIG. 5 is similar to the view depicted in FIG. 4, except that, in FIG. 5, the object of interest 502 is located near the left edge 504 of the frame. To accommodate such a situation, bounding boxes may be positioned such that, for example, the distance between the object of interest 502 and the center of the bounding box is minimized, subject to the constraint that the bounding box is entirely within the native-resolution frame.

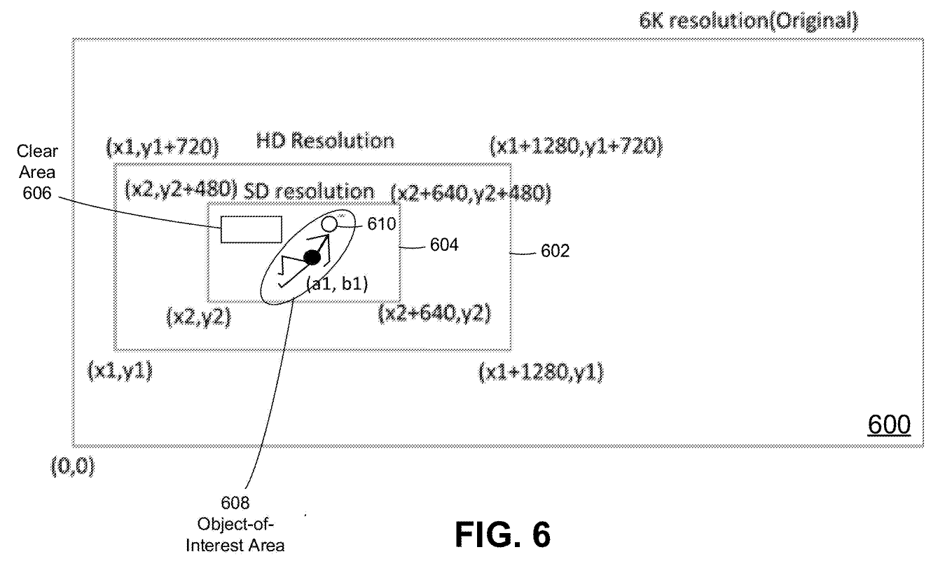

FIG. 6 illustrates a frame 600 of native-resolution video including the positions of an HD bounding box 602, an SD bounding box 604, a clear area 606, and an object-of-interest area 608. The view depicted in FIG. 6 is similar to the view depicted in FIG. 4, with a location of the object-of-interest area 608 and the clear area 606 added within the bounding boxes 602 and 604. Based on the location of an object of interest 610, object-of-interest area 608 is determined, illustrated here as an ellipse. Although the object of interest area 608 is depicted as an ellipse, it may have any shape, such as a square, a rectangle, a circle, an arbitrary object shape outline, and the like. Clear area 606 is identified outside of the object-of-interest area 608. The clear area 606 is located in proximity to the object-of-interest area 608. The clear area 606 may be defined using pixel coordinates of the respective video frame 600. The location of the clear area 606 may be transmitted to a client device. In response to user selection of object of interest 610, the client device may display annotation information regarding the selected object of interest 610 in the clear area 606. In some embodiments, different clear areas may be defined for different bounding boxes. For example, a clear area associated with the HD bounding box 602 may encompass a greater number of pixels than a clear area associated with the SD bounding box 604.

The selection of a clear area associated with an object of interest may be performed using a variety of techniques. In some embodiments, a clear area has a predetermined size (e.g. in pixels), which may be a different predetermined size for different types of bounding boxes, and the position of the clear area may be selected such that the clear area for a particular object of interest satisfies the following criteria: (i) the clear area falls within the corresponding bounding box; (ii) the clear area does not overlap any object-of-interest area (including the object-of-interest area corresponding to the clear area being positioned); and (iii) the distance between the clear area and the corresponding object of interest is minimized, subject to constraints (i) and (ii). In other embodiments, desirable characteristics may be given different cost functions, such that, for example, a cost is imposed for overlapping an object-of-interest area and a cost is imposed for greater distance from the relevant object of interest, and the location of the clear area is selected so as to minimize the total cost function.

In some embodiments, a user is provided with an option of selecting content within a particular bounding box. In response to a user selection, the video content within the bounding box is delivered as a separate stream to the user. For example, the user may select one or more objects of interest, and in response a streaming server may deliver the video content within a bounding box which contains the one or more objects of interest. One or more objects of interest and associated clear areas may be positioned within the bounding box. In response to a user selection, annotation data, such as the player's name, statistics, speed, and the like, may be displayed in clear areas. Locating the clear areas outside of all of the object-of-interest areas prevents the displayed annotation data from obstructing the object-of-interest areas, such as the players, the ball, and the like.

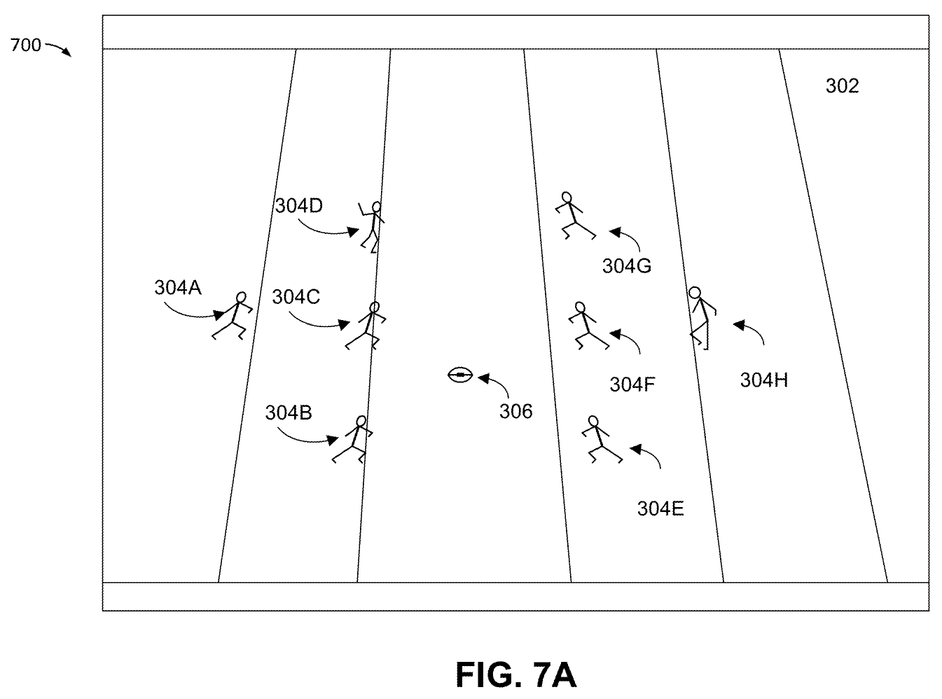

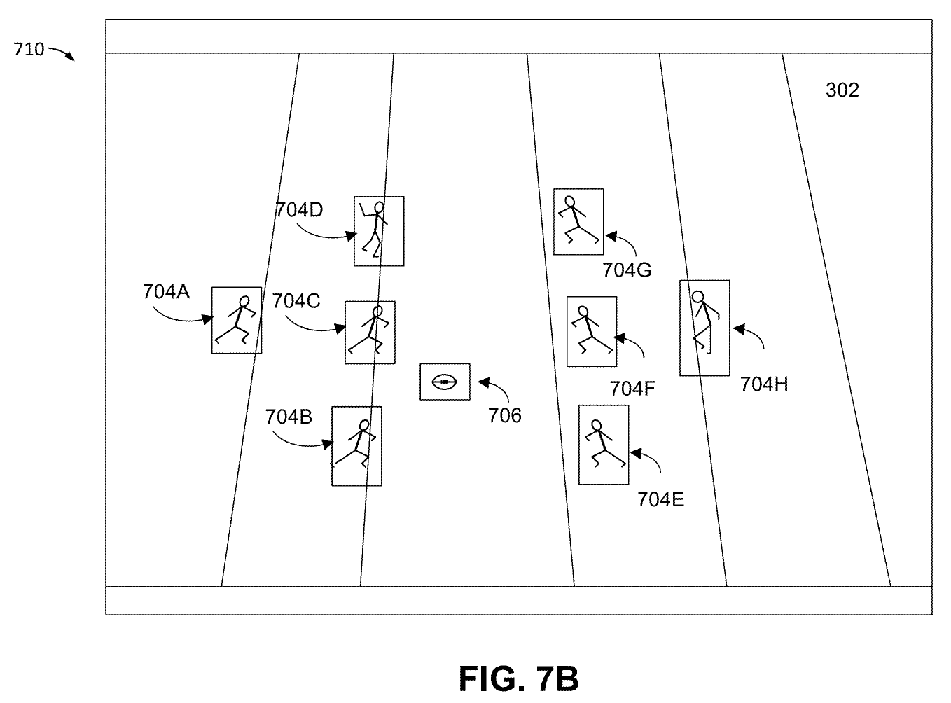

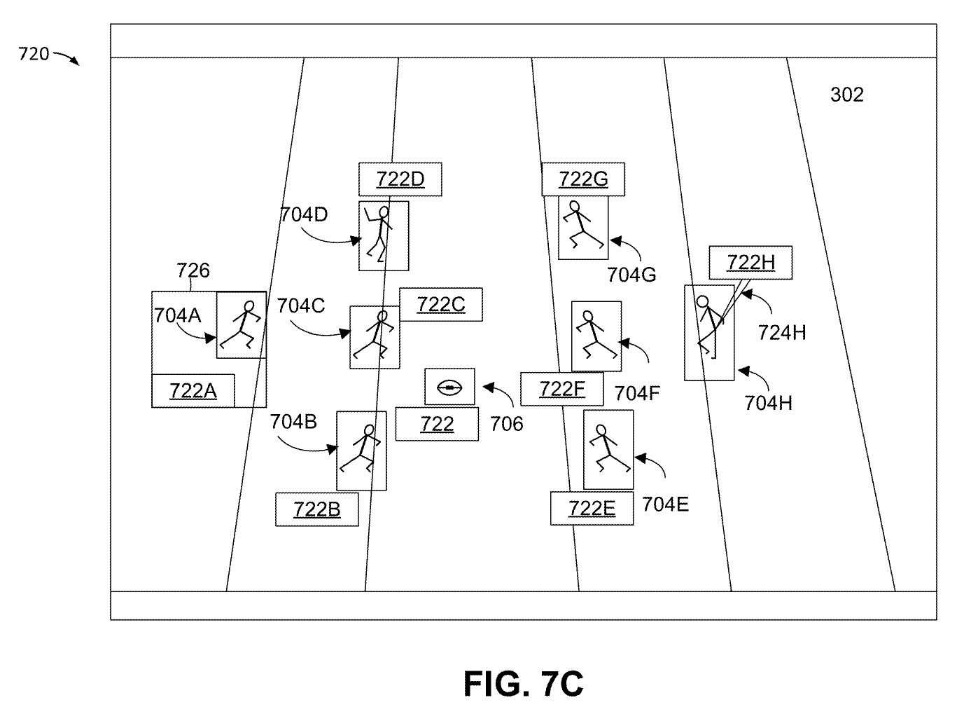

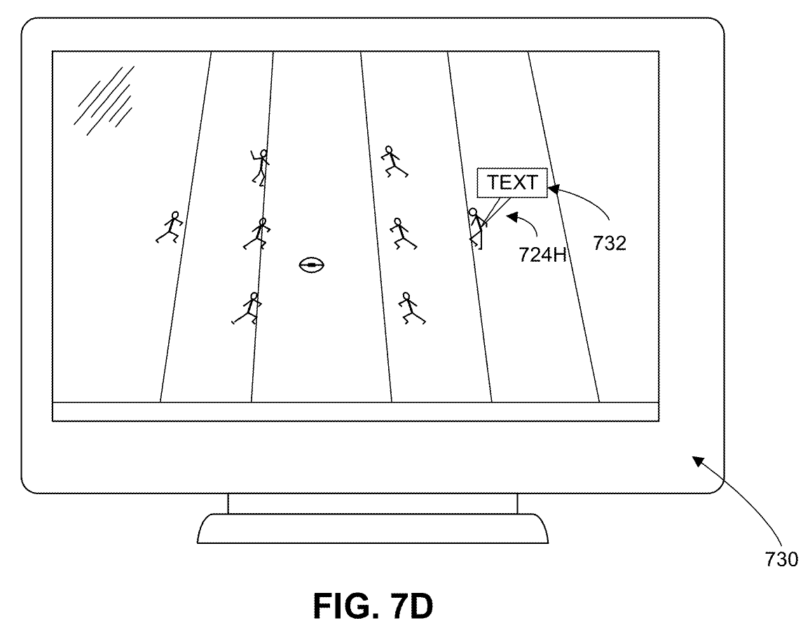

FIG. 7A depicts a view 700 of a video frame, in accordance with an embodiment. The view 700 is a view of the video frame from the perspective of the camera 308 of FIG. 3. The view 700 includes portions of the field 302, four players on the left (304A-D), the ball 306 in the center, and four players on the right (304E-H). A real time location system determines the physical location of each of the players 304A-H and the ball 306 (e.g., based on RFID tags). The physical locations are fused with the locations of the respective objects (i.e., players 304 and ball 306), in the video frame.

FIG. 7B depicts a view 710 of a video frame, in accordance with an embodiment. The objects present in view 710 include the objects of the view 700 of FIG. 7A. Also depicted in the view 710 are object-of-interest areas. Each of the objects of interest has a determined object-of-interest area, as depicted by the rectangles 704A-H around the players 304A-H and the rectangle 706 around the ball 306. As discussed above, the object-of-interest areas indicate areas that are preferably not obstructed in cases where annotation data is displayed (e.g. overlaid) on the video frame.

FIG. 7C depicts a view 720 of a video frame with object of interest and clear areas, in accordance with an embodiment. View 820 includes the components depicted in view 710 of FIG. 7B, and further includes clear areas 722 and 722A-H. The clear area 722 is related to the object-of-interest area 706 for the ball, and the clear areas 722A-H are related to the objects-of-interest areas 704A-H for each of the players, respectively. Some of the clear areas may be linked to the respective object-of-interest areas with a place for an indicator to be displayed. For example, 724H is an indicator between the clear area 722H and the object-of-interest area 704H.

In some embodiments, a bounding box is determined for each object of interest. The bounding box associated with an object of interest includes both the object-of-interest area and the related clear area. For example, a bounding box 726 for the player in area 704A may include all of the video from the bottom left corner of the clear area 722A to the top right corner of the object-of-interest area 704A.

FIG. 7D depicts a display device 730 (e.g. a television or computer monitor) on which a video is being displayed, in accordance with an embodiment. In particular, display device 730 depicts the view of the football game shown in the view 700 of FIG. 7A with annotation data 732 displayed. In this embodiment, a user has requested annotation data related to the player 304H (the right-most player as illustrated in FIG. 7A) to be displayed. The clear area 722H of FIG. 7C related to the object-of-interest area 704H of FIG. 7C, is used as the position of the text of the annotation data 732, which may include the player's name, the player's position, current statistics of the player, and/or the like. In some embodiments, the indicator 724H is displayed linking the text of the annotation data 732 with the location of the respective object of interest.

In some embodiments, determining the bounding boxes may be performed over several frames. A sufficiently long sequence of frames may be analyzed to ensure the motion of clear areas (e.g. the repositioning of a clear area relative to the object of interest area to which the clear are corresponds) is not excessive. For example, if an object of interest progresses rapidly from the left side of the display to the right side of the display in a small number of frames, a clear area initially identified directly to the right of the object of interest would potentially be moved out of the way as the object of interest traverses the screen from left to right over the course of several frames. This may be distracting to a user to see the displayed annotation data quickly jumping around the screen. In such an embodiment, the fuse mapper or other component may select a placement of the clear area that is initially above and to the right of the object of interest's location at the initial frame. Then, as the object of interest moves to the right, it passes under the clear area, allowing the clear area to remain relatively stationary as displayed on the video display. In a similar fashion, the changing relationships between objects of interest as they move around may call for adjustments in the positioning of the clear areas, since the location of clear areas may be selected so as not to obscure nearby objects of interest. Therefore when determining the position of a clear area, the system may analyze the object of interest areas across multiple frames (e.g. over a time interval) so that the clear area is selected to reduce or to minimize adjustment to the position of the clear area relative to the object of interest to which it corresponds. For example, the clear area may be selected to avoid collisions with other object-of-interest areas and with the boundaries of the screen or the display bounding box.

### Video Delivery Method

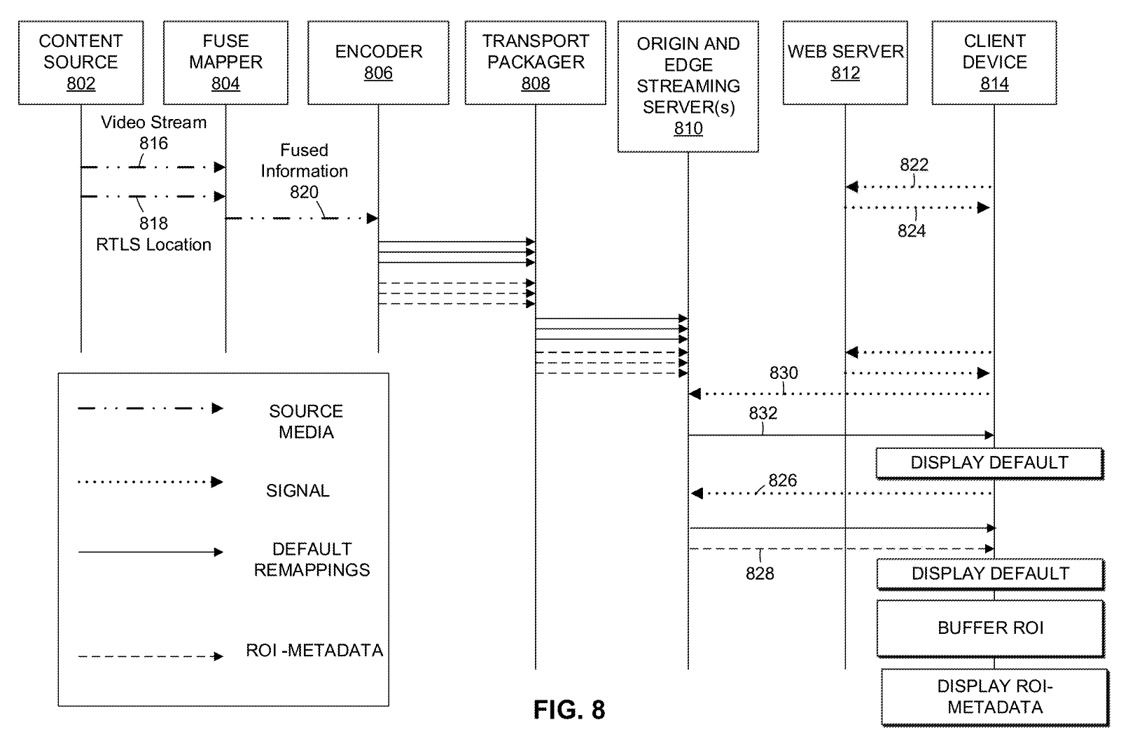

FIG. 8 is a first message flow diagram, in accordance with an embodiment. In particular, FIG. 8 illustrates the operation of an exemplary video delivery system, depicting communications between a content source 802, a fuse mapper 804, an encoder 806, a transport packager 808, an origin server and an edge streaming server (collectively referred to herein as streaming server 810, a web server 812, and a client device 814.

The content source 802 transmits a compressed or uncompressed media stream (video stream 816) of the source media to the fuse mapper 804. Additionally, location information (RTLS Location 818) associated with objects of interest is also transmitted to the fuse mapper 814. Location information is added to each frame for the objects of interest. The fuse mapper 804 then transmits the fused video and location information (fused information 820) to the encoder 806 at a high bit depth. The locations of the object-of-interest areas and the related clear areas are included in the transmission to the encoder 806. The encoder 806 may separately create ABR streams with default tone mappings and in some embodiments ABR streams with alternative tone remappings in various regions of interest (or combinations thereof). The various ABR streams with both the fused location and video information are transmitted to the transport packager 808. The transport packager 808 may segment the files and make the files available via an ftp or http download and prepare a manifest.

Note that the content preparation entities and steps shown in FIG. 8 are by way of example and should not be taken as limiting. Variations are possible, for example entities may be combined at the same location or into the same physical device. Also, the segmented media content may be delivered to an origin server, to one or multiple edge streaming servers, to a combination of these server types, or any suitable media server from which a media client may request the media content. A manifest file (e.g. a DASH MPD) that describes the media content may be prepared in advance and delivered to the streaming server (e.g. the origin server and/or the edge streaming server), or the manifest file may be generated dynamically in response to a client request for the manifest file.

The client device 814 may transmit a signal 822 to the web server 812 requesting to download the media content and may receive a streaming server redirect signal 824. The client device 814 may send a request 826 for a manifest which describes the available content files (e.g. media segment files). The request 826 may be sent from the client 814 to a server. The server (e.g., origin server or an edge streaming server) may deliver the manifest file 828 in response to the client request 826. The manifest 828 may indicate availability of the various ABR streams, region-of-interest areas, clear areas, bounding box areas, annotation data or metadata for the various objects of interest, and the like.

Initially, the client 814 may send a request 830 for a default stream to the streaming server 810, and the streaming server 810 may responsively transmit the default stream (e.g. media segments of that default stream) 832 to the client device 814. The client device 814 may display the default stream 832.

The client device 814 may detect a cue to request streams associated with particular bounding boxes or objects of interest. For example, the cue may be user input wherein the user selects a player or other object of interest associated with a bounding box.

In some embodiments, the client device 814 requests a stream with metadata that identifies clear areas, and the streaming server 810 responsively streams the requested stream to the client device. In some embodiments, an additional cue is received to zoom in on the region of interest associated with an object of interest.

In some embodiments, the fuse mapper 804 may include location information of all objects of interest in at a venue. However, only the relevant location information corresponding to the camera image is laid on top of the pixel coordinates on a frame by frame basis. The fuse mapper 804 thus outputs both video data and coordinates of the players/objects identified by the real time location system in the form of per-frame metadata that identifies the player object in the camera pixel domain. The coordinates of the objects of interest, and the related clear areas, region-of-interest areas are updated as the objects location is updated.

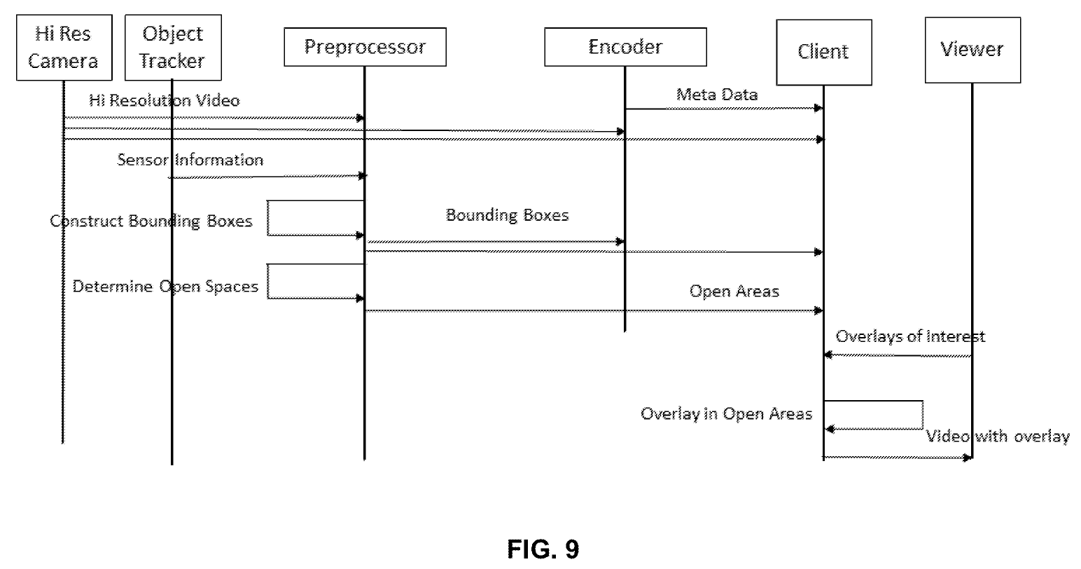

FIG. 9 is a second message flow diagram, in accordance with an embodiment. In particular, FIG. 9 illustrates the operation of an exemplary video delivery system, depicting communications between a camera, an object tracker, a preprocessor, an encoder, a client device, and a viewer.

As depicted in FIG. 9, a camera transmits video to a preprocessor, an encoder, and the client device. The pre-processor may be similar to the fuse mapper discussed in FIG. 8. The object tracker determines the location of the objects of interest and transmits the data to a preprocessor. The preprocessor fuses the video information with the location information to determine bounding boxes and object-of-interest areas for the video frames. The bounding boxes are transmitted to the encoder and the client device. After the areas related to the objects of interest are determined, open spaces, or clear areas, may be determined. The clear areas may be determined such that these areas do not overlap the object-of-interest areas in a current frame, do not overlap the object-of-interest areas over multiple frames or over a time interval, or such that the overlap between the clear areas and the object of interest areas is reduced or minimized for the current frame or for a time interval. The locations of the clear areas are transmitted to the client device. A viewer can select overlays of interest associated with different objects of interest. The client device can also receive and/or retrieve annotation data associated with the selected overlay of interest and display video with the annotation data being displayed within the determined open area.

### Object of Interest Tracking Metadata

In some embodiments, the result of mapping the real time locations of an object of interest to the camera pixel 2D image space is a (x, y) pixel position in the camera 2D image. The (x, y) pixel position moves according to the location-tracking results of the objects of interest, for example, as the players move across the field. The size of the object-of-interest area that contains the object may also be determined by the fusion mapper based on the camera parameters: zoom setting, camera angle, camera location, and the like. The camera and focus and zoom may be changing dynamically as the camera operator follows the action. In some cases, the camera can also be moving, for example with a handheld or aerial camera. The camera may further include an RFID tag and the real time location service may be able to determine the camera's location.

The client, or viewer, may request metadata and video streams for different scenarios. In one scenario, the client requests overlay of highlights on tracked objects during video playback of the full field view. In another scenario, the client requests overlay of object information useful for a client viewer such as speed of the object, distance to other objects, various other object statistics, and the like. The real-time location service may further be configured to determine the location-based metadata. For example, during a broadcast of a golf tournament, locations of the tee box, the golf ball, and the hole may be determined, and the determined drive distance and distance to the pin after a player hits the golf ball may be displayed in the clear area. In another example scenario, the client uses the metadata to request specific zoom streams from the server.

Embodiments disclosed herein may be employed in an MPEG-DASH ABR video distribution system. Metadata such as the identity and location of objects of interest, the location of clear areas, and annotation information regarding the objects of interest may be contained in the DASH MPD (or other streaming protocol manifest) and/or in the user data of the video elementary stream to provide for frame by frame updates. A client device may first read the manifest on start up for initial object information, and then continually update the object track information by parsing the video frame elementary data. Object-of-interest metadata may be available in-band or from a separate metadata file and may be used to update the user interface or other components related to selection and display of objects of interest and associated annotation data.

The following parameters may be conveyed in exemplary embodiments:
Num_Objects: Range 0-255, defines the number of objects to be defined in the current list. If Num Objects is greater than zero, then the following parameters are provided for each of the Num Objects objects, each of which may pertain to an object of interest.
Object_ID: Range 0-255. This syntax element provides a unique identifier for each object of interest.
Object_x_position[n]: For each object ID n, the x position of the object-of-interest area.
Object_y_position[n]: For each object ID n, the y position of the object-of-interest area.
Object_x_size[n]: For each object ID n, the x_dimension of the object-of-interest area.
Object_y_size[n]: For each object ID n, the y_dimension of the object-of-interest area.
Object_UserData[n]: For each object ID n, User Data can be included to be used by the Client to present User Interface Selection Criteria for the Object.
Object_metadata_x_position[n]: For each object ID n, the x position of the clear area in which user data or other annotation data regarding the object can be placed.
Object_metadata_y_position[n]: For each object ID n, the y position of the clear area where user data or other annotation data regarding the object can be placed.
Object_metadata_x_size[n]: For each object ID n, the x dimension of the clear area where user data or other annotation data regarding the object can be placed.
Object_metadata_y_size[n]: For each object ID n, the y dimension of the clear area where user data or other annotation data regarding the object can be placed.

Object x,y position and size may be provided in pixel units that correspond to the first-listed representation in the appropriate adaption set. For secondary representations (if they exist), the Object x,y size and position values are scaled to the secondary representations picture dimensions with a linear scale factor.

A client device by receiving an MPD or in-band data with the above-identified information can represent the object of interest on the user interface in a variety of ways. A Annotation Property of an adaption set indicates to the client how many objects of interest are available. Object UserData may be used by the client to display information describing aspects of the object of information. For example, in a sports game this can be specific player information.

### Exemplary Methods for Determination of Object of Interest and Clear Area

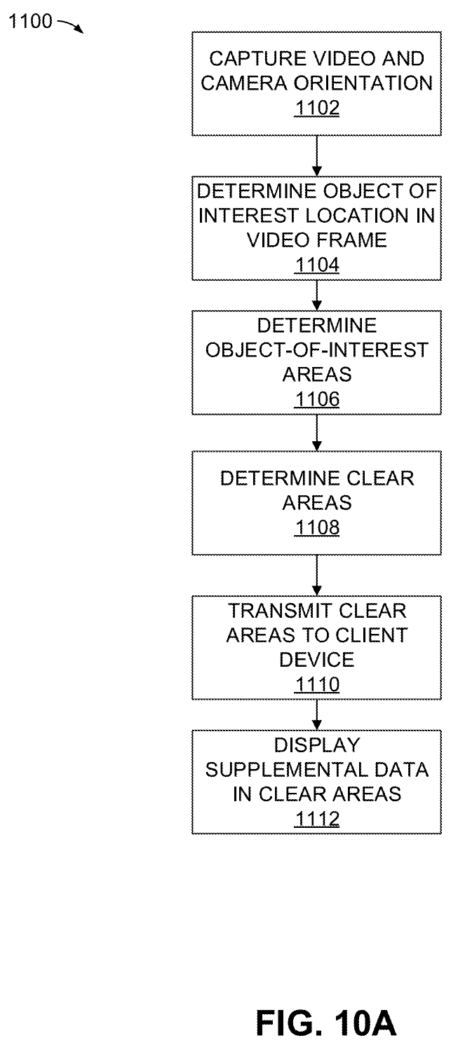

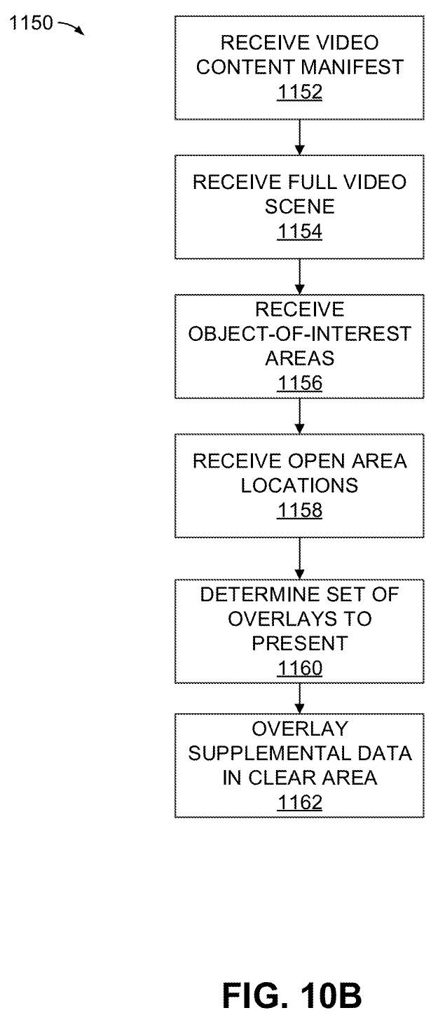

FIG. 10A depicts a first method, in accordance with an embodiment. In particular, FIG. 10A depicts the method 1100 that includes capturing video and camera orientation at 1102, determining object-of-interest locations in the video frame at 1104, determining object-of-interest areas at 1106, determining clear areas at 1108, transmitting locations of clear areas to a client device at 1110, and displaying annotation data in clear areas at 1112.

At 1102, a camera captures video, which may be at high resolution, of a scene. The camera is also configured to detect its location, pan, tilt, optical zoom, focal settings, and the like. At 1104, the location of an object of interest is determined in the video frame. An object of interest's location may be determined by a real-time location tracking system, such as RFID, and based on the determined locations of the object of interest and the camera's position, the location of each object of interest may be determined within the video frame.

At 1106, an object-of-interest area is determined within the video frame for each object of interest. The object-of-interest area is defined by a set of pixels of the video frame. At 1108, clear areas, that do not overlap any of the determined object-of-interest areas, are determined. The clear areas may be in a close visual proximity to the object-of-interest area. The clear areas are used as locations within which to display annotation data associated with the object of interest. At 1110, the clear area locations are transmitted to the client device on a per frame basis. At 1112, the client device displays annotation data associated with the object of interest in the clear areas.

FIG. 10B depicts a second method, in accordance with an embodiment. In particular, FIG. 10B depicts the method 1150 that includes receiving a video content manifest at 1152, receiving a full video scene at 1154, receiving object-of-interest areas at 1156, receiving clear area locations at 1158, determining a set of overlays to present at 1160, and overlaying annotation data in open areas at 1162.

At 1150, metadata related to video content is received at the client device. The metadata may include supplemental information about objects of interest, such as a player's name. At 1152-1158, the video frame, descriptions of object-of-interest areas, and descriptions of clear, or open, areas are received. At 1160, the set of overlays to be presented on a display device are determined. The client device may display the video frame without annotations until a selection of overlays is made. In some embodiments, a first user device, such as a television, receives the video frame, and a second user device, such as a smartphone, receives the metadata about the video contents and functions as a user interface for the user to select overlays to be displayed on the first user device. At 1162, a user device displays the video with overlaid annotation data within the clear areas.

In some embodiments, an indicator connects the clear area displaying annotation data and the object of interest area. In some embodiments, the color, font, and graphics of each overlay may be specified as an attribute in the metadata.

In some embodiments, selection of the overlay and annotation data to be displayed may satisfy certain conditions. For example, one condition a viewer may select is to display annotation data associated with a player when the player is in control of the playing ball. In such an embodiment, the location of the ball and the location of the different objects of interest on the field are determined. When the location of the ball and a player's object of interest overlap, the fuse mapper correlates the player as in possession of the ball and includes this correlation in the metadata. When selected, the display device will display the name of the player in the clear area associated with the player.

Similarly, when the location of the game ball is not associated with another player, for example, the football is being passed from a first player to a second player, the video device displays the video with the name of the first player when the first player is in possession of the ball, displays a statistic related to the ball (such as ball speed, a determined projected second player's name based on the ball's and the player's trajectories, a completion percentage, and the like) in the clear area associated with the ball while the ball is traveling through the air, and the second player's name in the clear area associated with the second player after she catches the ball. In an embodiment, the annotation data to be displayed for a given object of interest may be selected from a larger set of supplemental data available for the object, and the client may format the selected annotation data appropriately to fit the clear area available for the object. For example, a given object of interest may have fields such as “Player Name”, “Player Team”, “Player Position”, and “Completion Percentage.” At a given time, the subset “Player Name” and “Player Position” may be selected and these two fields may be displayed in the clear area. Selection of the annotation data may be based on user input, previously set user preferences, signaling from the server as to which annotation data fields are currently important, and/or the like.

### Exemplary Client and Server Hardware

Note that various hardware elements of one or more of the described embodiments are referred to as “modules” that carry out (i.e., perform, execute, and the like) various functions that are described herein in connection with the respective modules. As used herein, a module includes hardware (e.g., one or more processors, one or more microprocessors, one or more microcontrollers, one or more microchips, one or more application-specific integrated circuits (ASICs), one or more field programmable gate arrays (FPGAs), one or more memory devices) deemed suitable by those of skill in the relevant art for a given implementation. Each described module may also include instructions executable for carrying out the one or more functions described as being carried out by the respective module, and it is noted that those instructions may take the form of or include hardware (i.e., hardwired) instructions, firmware instructions, software instructions, and/or the like, and may be stored in any suitable non-transitory computer-readable medium or media, such as commonly referred to as RAM, ROM, etc.

Exemplary embodiments disclosed herein are implemented using one or more wired and/or wireless network nodes, such as a wireless transmit/receive unit (WTRU) or other network entity.

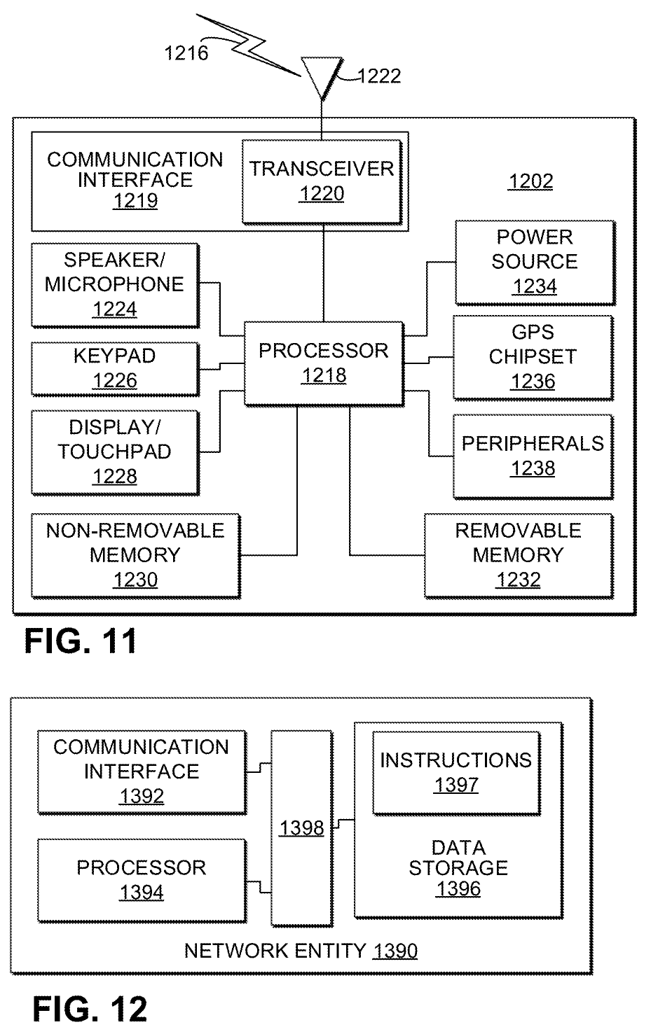

FIG. 11 is a system diagram of an exemplary WTRU 1202, which may be employed as a client device or other component in embodiments described herein. As shown in FIG. 11, the WTRU 1202 may include a processor 1218, a communication interface 1219 including a transceiver 1220, a transmit/receive element 1222, a speaker/microphone 1224, a keypad 1226, a display/touchpad 1228, a non-removable memory 1230, a removable memory 1232, a power source 1234, a global positioning system (GPS) chipset 1236, and sensors 1238. It will be appreciated that the WTRU 1202 may include any sub-combination of the foregoing elements while remaining consistent with an embodiment.

The processor 1218 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 1218 may perform signal coding, data processing, power control, input/output processing, and/or any other functionality that enables the WTRU 1202 to operate in a wireless environment. The processor 1218 may be coupled to the transceiver 1220, which may be coupled to the transmit/receive element 1222. While FIG. 11 depicts the processor 1218 and the transceiver 1220 as separate components, it will be appreciated that the processor 1218 and the transceiver 1220 may be integrated together in an electronic package or chip.

The transmit/receive element 1222 may be configured to transmit signals to, or receive signals from, a base station over the air interface 1216. For example, in one embodiment, the transmit/receive element 1222 may be an antenna configured to transmit and/or receive RF signals. In another embodiment, the transmit/receive element 1222 may be an emitter/detector configured to transmit and/or receive IR, UV, or visible light signals, as examples. In yet another embodiment, the transmit/receive element 1222 may be configured to transmit and receive both RF and light signals. It will be appreciated that the transmit/receive element 1222 may be configured to transmit and/or receive any combination of wireless signals.

In addition, although the transmit/receive element 1222 is depicted in FIG. 11 as a single element, the WTRU 1202 may include any number of transmit/receive elements 1222. More specifically, the WTRU 1202 may employ MIMO technology. Thus, in one embodiment, the WTRU 1202 may include two or more transmit/receive elements 1222 (e.g., multiple antennas) for transmitting and receiving wireless signals over the air interface 1216.

The transceiver 1220 may be configured to modulate the signals that are to be transmitted by the transmit/receive element 1222 and to demodulate the signals that are received by the transmit/receive element 1222. As noted above, the WTRU 1202 may have multi-mode capabilities. Thus, the transceiver 1220 may include multiple transceivers for enabling the WTRU 1202 to communicate via multiple RATs, such as UTRA and IEEE 802.11, as examples.

The processor 1218 of the WTRU 1202 may be coupled to, and may receive user input data from, the speaker/microphone 1224, the keypad 1226, and/or the display/touchpad 1228 (e.g., a liquid crystal display (LCD) display unit or organic light-emitting diode (OLED) display unit). The processor 1218 may also output user data to the speaker/microphone 1224, the keypad 1226, and/or the display/touchpad 1228. In addition, the processor 1218 may access information from, and store data in, any type of suitable memory, such as the non-removable memory 1230 and/or the removable memory 1232. The non-removable memory 1230 may include random-access memory (RAM), read-only memory (ROM), a hard disk, or any other type of memory storage device. The removable memory 1232 may include a subscriber identity module (SIM) card, a memory stick, a secure digital (SD) memory card, and the like. In other embodiments, the processor 1218 may access information from, and store data in, memory that is not physically located on the WTRU 1202, such as on a server or a home computer (not shown).

The processor 1218 may receive power from the power source 1234, and may be configured to distribute and/or control the power to the other components in the WTRU 1202. The power source 1234 may be any suitable device for powering the WTRU 1202. As examples, the power source 1234 may include one or more dry cell batteries (e.g., nickel-cadmium (NiCd), nickel-zinc (NiZn), nickel metal hydride (NiMH), lithium-ion (Li-ion), and the like), solar cells, fuel cells, and the like.

The processor 1218 may also be coupled to the GPS chipset 1236, which may be configured to provide location information (e.g., longitude and latitude) regarding the current location of the WTRU 1202. In addition to, or in lieu of, the information from the GPS chipset 1236, the WTRU 1202 may receive location information over the air interface 1216 from a base station and/or determine its location based on the timing of the signals being received from two or more nearby base stations. It will be appreciated that the WTRU 1202 may acquire location information by way of any suitable location-determination method while remaining consistent with an embodiment.

The processor 1218 may further be coupled to other peripherals 1238, which may include one or more software and/or hardware modules that provide additional features, functionality and/or wired or wireless connectivity. For example, the peripherals 1238 may include sensors such as an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 12 depicts an exemplary network entity 1390 that may be used in embodiments of the present disclosure, for example as an encoder, transport packager, origin server, edge streaming server, web server, or client device as described herein. As depicted in FIG. 12, network entity 1390 includes a communication interface 1392, a processor 1394, and non-transitory data storage 1396, all of which are communicatively linked by a bus, network, or other communication path 1398.

Communication interface 1392 may include one or more wired communication interfaces and/or one or more wireless-communication interfaces. With respect to wired communication, communication interface 1392 may include one or more interfaces such as Ethernet interfaces, as an example. With respect to wireless communication, communication interface 1392 may include components such as one or more antennae, one or more transceivers/chipsets designed and configured for one or more types of wireless (e.g., LTE) communication, and/or any other components deemed suitable by those of skill in the relevant art. And further with respect to wireless communication, communication interface 1392 may be equipped at a scale and with a configuration appropriate for acting on the network side—as opposed to the client side—of wireless communications (e.g., LTE communications, Wi-Fi communications, and the like). Thus, communication interface 1392 may include the appropriate equipment and circuitry (perhaps including multiple transceivers) for serving multiple mobile stations, UEs, or other access terminals in a coverage area.

Processor 1394 may include one or more processors of any type deemed suitable by those of skill in the relevant art, some examples including a general-purpose microprocessor and a dedicated DSP.

Data storage 1396 may take the form of any non-transitory computer-readable medium or combination of such media, some examples including flash memory, read-only memory (ROM), and random-access memory (RAM) to name but a few, as any one or more types of non-transitory data storage deemed suitable by those of skill in the relevant art could be used. As depicted in FIG. 12, data storage 1396 contains program instructions 1397 executable by processor 1394 for carrying out various combinations of the various network-entity functions described herein.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Additional Examples are provided below.

An Example 1 is an apparatus that includes a video server configured to:
identify a plurality of object-of-interest areas in at least one frame of a video stream;
select an annotation area for each of the object-of-interest areas such that each annotation area does not overlap any object-of-interest area in the frame; and
deliver the video stream, annotation data regarding each of the respective object-of-interest areas, and location data identifying the location of each annotation area within the frame, to a client device.

In an Example 2, the video server is further configured to:
track a real-world position of a first object of interest;
determine at least an orientation of a camera capturing the frame; and
fuse the real-world position of the first object of interest and the orientation of the camera to determine a frame position of the first object of interest within the frame;
select a first one of the first object-of-interest areas to at least partially surround the frame position of the first object of interest.

In an Example 3, the video server of Example 2 is further configured to track the real-world position of the first object of interest using a radio-frequency identification (RFID) tag on the first object of interest.

In an Example 4, the client device of Example 1 is configured to:
receive the video stream, the annotation data, and the location data;
present the video stream at a display; and
display the annotation data associated with the selected object of interest in the annotation area associated with the selected object of interest, in response to a user input identifying a selected one of the objects of interest.

In an Example 5, the video server of Example 1 is further configured to deliver coordinates of each of the object-of-interest areas to the client device.

In an Example 6, the client device of Example 5 is configured to:
receive the video stream, the annotation data, the location data, and the coordinates of the object-of-interest areas;

present the video stream at a display; and
in response to a user input at a selected position in the frame,
identify a selected object-of-interest area enclosing the selected position based on the coordinates of the object-of-interest areas, and display the annotation data associated with the selected object-of-interest area in the associated annotation area.

In an Example 7, the location data location data identifying the location of each annotation area, of any of Examples 1-6, includes pixel coordinates.

In an Example 8, the annotation data of any of Examples 1-6 includes text data.

In an Example 9, the video server of any of Examples 1-6 is configured to provide the location data within user data associated with the video stream.

In an Example 10, the video server of any of Examples 1-6 is configured to provide the location data within a manifest file associated with the video stream.

In an Example 11, the video server of any of Examples 1-6 is configured to select the annotation areas so as not to overlap with one another.

In an Example 12, the video server of any of Examples 1-6 is configured to select each annotation area to be proximate to the respective object-of-interest area.

In an Example 13, the video server of any of Examples 1-6 is configured to select each annotation area to substantially track motion of the respective object-of-interest area over multiple frames.

In an Example 14, the video server of any of Examples 1-6 is configured to select each annotation area to preclude overlap of the annotation areas with edges of the respective frames.

An Example 15 is a video server that includes a processor and a non-transitory computer-readable medium storing instructions operative to perform functions that include:
identifying a plurality of object-of-interest areas in at least one frame of a video stream;
selecting an annotation area for each of the object-of-interest areas such that each annotation area does not overlap any object-of-interest area in the frame; and
delivering the video stream, annotation data regarding each of the respective object-of-interest areas, and location data identifying the location of each annotation area within the frame, to a client device.

An Example 16 is an apparatus that includes client device configured to:
receive a video stream, annotation data regarding each of multiple object-of-interest areas within at least one frame of the video stream, and location data identifying the location of each annotation area within the frame;
present the video stream at a display;
receive user input at a selected position of the frame;
identify a selected object-of-interest area enclosing the selected position based on the coordinates of the object-of-interest areas; and
display the annotation data associated with the selected object-of-interest area in the associated annotation area.

1. A video serving method, comprising:
identifying a plurality of object-of-interest areas in at least one frame of a video stream;
selecting an annotation area for each of the object-of-interest areas such that each annotation area does not overlap any object-of-interest area in the frame;
delivering to a recipient: (i) the video stream, (ii) annotation data regarding each of the respective object-of-interest areas, and (iii) location data identifying the location of each annotation area within the frame.

2. The method of claim 1, wherein identifying at least a first one of the object-of-interest areas comprises:
tracking a real-world position of a first object of interest;
determining at least an orientation of a camera capturing the frame; and
fusing the real-world position of the first object of interest and the orientation of the camera to determine a frame position of the first object of interest within the frame;
wherein the first object-of-interest area is selected to at least partially surround the frame position of the first object of interest.

3. The method of claim 2, wherein tracking the real-world position of the first object of interest is performed using a radio-frequency identification (RFID) tag on the first object of interest.

4. The method of claim 1, further comprising, at a client device:
receiving the video stream, the annotation data, and the location data;
presenting the video stream at a display; and
in response to a user input identifying a selected one of the objects of interest, displaying the annotation data associated with the selected object of interest in the annotation area associated with the selected object of interest.

5. The method of claim 1, wherein the delivering includes delivering coordinates of each of the object-of-interest areas.

6. The method of claim 5, further comprising, at a client device:
receiving the video stream, the annotation data, the location data, and the coordinates of the object-of-interest areas;
presenting the video stream at a display; and
in response to a user input at a selected position in the frame:
based on the coordinates of the object-of-interest areas, identifying a selected object-of-interest area enclosing the selected position; and
displaying the annotation data associated with the selected object-of-interest area in the associated annotation area.

7. The method of claim 1, wherein the location data identifying the location of each annotation area comprises pixel coordinates.

8. The method of claim 1, wherein the annotation data comprises text data.

9. The method of claim 1, wherein delivering the location data identifying the location of each annotation area comprises providing the location data within user data associated with the video stream.

10. The method of claim 1, wherein delivering the location data identifying the location of each annotation area comprises providing the location data within a manifest file associated with the video stream.

11. The method of claim 1, wherein the annotation areas are selected so as not to overlap with one another.

12. The method of claim 1, wherein each annotation area is selected so as to be proximate to the respective object-of-interest area.

13. The method of claim 1, wherein each annotation area is selected so as to substantially track motion of the respective object-of-interest area over multiple frames.

14. The method of claim 1, wherein each annotation area is selected so as to preclude overlap of the annotation areas with edges of the respective frames.

15. A video server comprising a processor and a non-transitory computer-readable medium storing instructions operative to perform functions comprising:
identifying a plurality of object-of-interest areas in at least one frame of a video stream;
selecting an annotation area for each of the object-of-interest areas such that each annotation area does not overlap any object-of-interest area in the frame;
delivering to a recipient: (i) the video stream, (ii) annotation data regarding each of the respective object-of-interest areas, and (iii) location data identifying the location of each annotation area within the frame.
